(19) United States
(12) Patent Application Publication
(10) Pub. No.: US 2013/0233352 A1
(43) Pub. Date: Sep. 12, 2013

(54) APPARATUS AND METHOD FOR MONITORING CLEANING

(71) Applicants: Peter Gattermeyer, Freising (DE); Gerald Hoheisel, Berlin (DE)

(72) Inventors: Peter Gattermeyer, Freising (DE); Gerald Hoheisel, Berlin (DE)

(73) Assignees: FLEXIM GMBH, BERLIN (DE); KRONES AG, NEUTRAUBLING (DE)

(21) Appl. No.: 13/879,542

(22) PCT Filed: Oct. 25, 2011
(86) PCT No.: PCT/EP11/05383

§ 371 Date: May 21, 2013

(30) Foreign Application Priority Data
Oct. 26, 2010 (DE) 10 2010 042 960.0

(51) Int. Cl. B08B 3/04

(52) U.S. Cl. CPC B08B 3/04
USPC 134/18; 134/56 R

(57) ABSTRACT

An apparatus and a method for monitoring the cleaning of the apparatus for at least one process container and/or at least one process line, and where the process container and/or process line can be cleaned by means of introducing a detergent solution, and with a measuring device for determining a first physical characteristic of the detergent solution, a measuring device for determining a second physical characteristic of the detergent solution, a measuring device for determining the temperature of the detergent solution, an evaluation unit which determines the detergent concentration in the detergent solution via the first and second physical characteristics and via the temperature of the detergent solution, and determines the continuance or termination of the cleaning and/or the re-concentration and/or replacement of the detergent as a function of the detergent concentration that is determined.

### CROSS-REFERENCE TO RELATED APPLICATION

The present application is the United States national phase of International Patent Application No. PCT/EP2011/005383, filed Oct. 25, 2011, which application claims priority of German Application No. 102010042960.0, filed Oct. 26, 2010. The entire text of the priority application is incorporated herein by reference in its entirety.

### FIELD OF THE DISCLOSURE

The disclosure relates to an apparatus, in particular to an apparatus for producing, treating and filling liquid foodstuffs, and to a method for monitoring the cleaning of this apparatus.

### BACKGROUND

Installations in food production plants or breweries as well as in the chemical or pharmaceutical industry need regular cleaning. For instance, in heated brewery units, where wort is boiled and kept hot, deposits are formed on the heating surfaces during the process, in particular caused by fouling (scorching of organic substances like sugar or protein), which have to be removed. Additionally known is the organic or mineral fouling, for instance, in fermentation tanks, which is caused without the action of heat.

Usually, a CIP (“cleaning in place”) process is used for cleaning the containers and conduits in a brewery plant, using a corresponding cleaning agent. In particular, aqueous alkaline (e.g. based on NaOH) and acidic (e.g. based on HNO₃) cleaning agent solutions are employed.

However, in conventional plants the progress of the cleaning action during the cleaning process and the quality of the cleaning agent reused in the cycle are impossible to be determined exactly, so that for the most part empirical values have to be relied on with respect to the duration and/or type of the cleaning process. Also, it is common practice to check the quality of the cleaning agent randomly by taking samples between the individual cleaning actions at different places in the plant, and manually determining the concentration of the cleaning agent in the cleaning agent solution by testing the samples in a laboratory. This is complicated and very expensive on the one hand, and is subject to the human error factor on the other hand (sample taking forgotten, wrong analysis results, communication gaps between quality inspection and production).

Moreover, apparatus and methods are known from the prior art which determine the concentration of the cleaning agent on the basis of the conductivity value. This, too, involves the problem that the progress of the cleaning action and/or the quality of the reused cleaning agent cannot be determined exactly. In addition, it is impossible to detect by means of the conventional plants and methods whether the cleaning agent has to be replaced.

Against this background, the cleaning in conventional brewery plants is carried out after a predetermined time and according to a predetermined cleaning schedule so as to allow a permanent and efficient cleaning success. For instance, the cleaning is always carried out after a certain process step or after a predetermined number of steps. The period chosen for the cleaning action is to be regarded as the maximum period, allowing the complete removal even of tenacious residues which may be caused by different production methods or different raw substances. This procedure is used above all in plants that are difficult to control. This means a waste of production time on account of cleaning time, as well as a waste of energy, water and cleaning agent. Also, as a precaution, the cleaning agent is completely replaced at predetermined time intervals.

### SUMMARY OF THE DISCLOSURE

Based on the foregoing it is one aspect of the present disclosure to provide an apparatus and a method for monitoring the cleaning of an apparatus, which allow a fast, efficient and exact determination during the cleaning whether the cleaning process has to be continued or may be discontinued, and/or whether the cleaning agent has to be re-concentrated and/or replaced prior to the start of a new cleaning process.

The disclosed apparatus comprises at least one process container and/or at least one process line, a cleaning device by means of which the process container and/or the process lines can be cleaned by introducing a cleaning agent solution, a measuring device for determining a first physical substance quantity, a measuring device for determining a second physical substance quantity, as well as a measuring device for determining the temperature of the cleaning agent solution. The apparatus further comprises an evaluation unit which determines the cleaning agent concentration in the cleaning agent solution on the basis of the first and second physical substance quantities and on the basis of the temperature of the cleaning agent solution. This evaluation unit also determines the continuation or discontinuation, and/or the re-concentration and/or the replacement of the cleaning agent depending on the determined cleaning agent concentration.

The first physical substance quantity differs from the second physical substance quantity. Physical substance quantities designate all physical parameters that change substance-specifically with the composition, for instance the refractive index, the electrical conductivity, the density, the sound velocity or the transmission speed of light. The terms “first” and “second” merely serve the differentiation of the substance quantities, i.e. they do not refer to a sequence in space or time.

In addition to the substance-specific composition both physical substance quantities are dependent on the thermodynamic state quantity temperature, which does not depend on the composition of the solution. Owing to this temperature dependence a measurement only of the two physical substance quantities is not sufficient to allow an exact determination of the composition of the solution. The temperature detection eliminates this problem.

The presence of the two measuring devices, which determine two independent physical substance quantities, i.e. the first and the second physical substance quantities, of the cleaning agent solution, allows in combination with the measured temperature value a targeted and exact determination of the cleaning agent concentration in the cleaning agent solution, so that the evaluation unit of the apparatus allows the effective control of the continuation or discontinuation of the cleaning process, and/or the re-concentration and/or the replacement of the cleaning agent.

Preferably, the refractive index is measured as the first physical substance quantity and the electrical conductivity is measured as the second physical substance quantity, as these substance quantities can be determined fast, exactly and effectively and are not adulterated, for instance, by gas contents in the cleaning agent solution.

In a preferred embodiment the measuring device for determining the temperature is integrated in the measuring device for determining the first physical substance quantity and/or in the measuring device for determining the second physical substance quantity. Also, all three measuring devices may be integrated in one unit. Thus, a compact and cost-efficient apparatus can be obtained.

The apparatus is in particular an apparatus for producing liquid foodstuffs, preferably a brewery plant. According to the disclosure it is also possible, however, to produce any optional products in the apparatus, e.g. for the chemical or pharmaceutical industries. The term “process container” includes all kinds of containers in the apparatus, preferably a mash or wort boiling device/device for keeping hot the wort and/or a fermenting or storage tank and/or a bottle washing machine, i.e. in particular all components of the plant that are subject to fouling. The term “process line” includes all lines and/or connecting parts contained in the apparatus, e.g. pipelines for the transport of media, educts or products, valves or connectors.

It is preferred that the cleaning agent solution is an aqueous solution which contains NaOH as cleaning agent. As an alternative to NaOH other alkaline cleaning agents are included as well, however, e.g. KOH, as well as acidic cleaning agents or surfactants. The use of NaOH as cleaning agent allows the effective removal of organic and inorganic residues. NaOH especially decomposes organic residues like sugar or proteins, which reduces the concentration of the NaOH as active cleaning agent in the cleaning agent solution.

The production of liquid foodstuffs, e.g. beer, may involve the presence of CO₂ in the apparatus, which is produced in the reaction process and/or is introduced into the apparatus via the ambient air. Thus, in the cleaning process with aqueous NaOH, Na₂CO₃ is produced which is additionally present in the cleaning solution. However, compared to NaOH, this Na₂CO₃ has a reduced or no cleaning effect. NaOH is also called an active constituent of the cleaning agent. The measuring devices in the apparatus according to the disclosure, which determine both a first physical substance quantity and a second physical substance quantity different from the first physical substance quantity, as well as the temperature of the cleaning agent solution, allow an effective and exact determination of the NaOH concentration.

The determination of the concentration of the NaOH lye is, in particular, also possible although the dilution effect with water caused by the consumption of NaOH and the increase of dissolved Na₂CO₃ affect the refractive index and the electrical conductivity of the cleaning agent and render the determination of the NaOH concentration more difficult. The combined determination of these two parameters, i.e. refractive index and conductivity, by means of the evaluation unit allows in contrast to the determination of only one parameter, i.e. refractive index or conductivity, a substantially more exact determination of the cleaning agent concentration. This allows a fast, efficient and exact determination of the cleaning agent concentration during the cleaning. Also, a safe decision may be made whether the cleaning process has to be continued or can be discontinued.

Also, the determination of the cleaning agent concentration is not dependent on the contamination degree of the solution, which is caused by decomposition products. Dissolved ions of the decomposition products, which would adulterate a simple conductivity measurement, and dissolved decomposition products, which would adulterate a simple measurement of the refractive index, are compensated by the combination of conductivity and refractive index. Unknown decomposition products do, therefore, not interfere with the determination of the cleaning agent concentration. Moreover, it is possible to determine whether the cleaning agent concentration is still enough for an efficient cleaning process, or whether the cleaning agent has to be re-concentrated and/or replaced.

It is further preferred that the apparatus comprises a circulation unit with a circulation pump, by means of which the process container and the cleaning device are connected to each other, and wherein the circulation unit comprises a discharge line from the process container to the circulation pump and a supply line from the circulation pump to the process container. Such an embodiment allows a particularly fast and efficient monitoring of the cleaning process.

In particular, the measuring device for determining the first physical substance quantity and/or the measuring device for determining the second physical substance quantity and/or the measuring device for determining the temperature may be located in the circulation unit, preferably in the discharge line, as a determination of the measurement parameters performed there can provide particularly fast and exact measurement data. This allows a particularly fast and efficient determination whether the cleaning process has to be continued or may be discontinued, and/or whether the cleaning agent has to be re-concentrated and/or replaced.

The method comprises the following steps:

a) cleaning an apparatus with a cleaning agent solution, wherein the cleaning agent is chemically transformed during the cleaning,

b) measuring a first and a second physical substance quantity, and measuring the temperature of the cleaning agent solution,

c) determining the cleaning agent concentration in the cleaning agent solution on the basis of the first and second physical substance quantities and on the basis of the temperature of the cleaning solution,

d) continuing or discontinuing the cleaning, and/or re-concentrating and/or replacing the cleaning agent depending on the determined cleaning agent concentration.

The method comprises a combined measurement of two independent physical substance quantities and the temperature of the cleaning agent solution. This allows the fast, effective and exact determination of the active cleaning agent concentration in the cleaning agent solution, resulting in an improved course of the process as it can be determined fast and effectively whether the cleaning has to be continued or may be discontinued. Alternatively thereto, or in combination therewith, it becomes possible to determine on the basis of the determined cleaning agent concentration whether it is necessary to re-concentrate and/or replace the cleaning agent.

In particular, the first physical substance quantity in the method is the refractive index, and the second physical substance quantity in the method is the electrical conductivity. Preferably, the method serves the cleaning of an apparatus for producing liquid foodstuffs, in particular a brewery plant, and wherein the process container preferably is a mash or wort boiling device/device for keeping hot the wort and/or a fermenting or storage tank and/or a bottle washing machine. The cleaning agent solution is an aqueous solution which contains NaOH as cleaning agent, and wherein the cleaning agent solution further contains Na₂CO₃ in step b). The advantages associated therewith were explained in the description of the apparatus and are transferable to the method.

Further, it is preferred that the measurement of the first and second physical substance quantities and of the temperature of the cleaning agent solution in step b) of the method is carried out continuously or at intervals during the cleaning, i.e. is a so-called inline measurement. In such an embodiment of the method no samples have to be taken from the apparatus, which provides for a fast and effective possibility of monitoring the cleaning of the apparatus.

In particular, the determination of the cleaning agent concentration in step c) may be carried out by a calibration curve. In this case, the evaluation unit compensates the temperature dependence of the two physical substance quantities on the basis of stored calibration curves, and determines the value of the two physical substance quantities at a standard temperature, e.g. 20° C. The determined concentration dependences of the first and the independent second physical substance quantities at the standard temperature are then converted in the evaluation unit, on the basis of calibration curves, into the active cleaning agent concentration in the cleaning agent solution, so that a fast and effective course of the procedure is possible.

The measurement of the first physical substance quantity and/or the measurement of the second, independent physical substance quantity and/or of the temperature of the cleaning agent solution is preferably carried out in step b) in the circulation unit, in particular preferably in the discharge line. This allows the fast and targeted determination of the two physical substance quantities and the temperature, and the method for monitoring the cleaning of the apparatus can thus be performed particularly effectively.

### BRIEF DESCRIPTION OF THE DRAWINGS

The disclosure and the advantages thereof are additionally explained by means of the exemplary embodiments illustrated in the drawings. In the drawings:

FIG. 1 shows a schematic sectional drawing of an apparatus according to the disclosure;

FIG. 2 shows a schematic sectional drawing of a refractometer for determining the refractive index;

FIG. 3 shows a schematic graphic representation of the change of the NaOH and Na₂CO₃ concentrations with time during the cleaning;

FIG. 4 shows a schematic graphic representation to illustrate the dependence of the conductivity on the NaOH concentration and the Na₂CO₃ concentration;

FIG. 5 shows a schematic graphic representation to illustrate the dependence of the refractive index on the NaOH concentration and the Na₂CO₃ concentration;

FIG. 6 shows a table containing measured values according to Example 1;

FIG. 7 shows a table containing measured values according to Example 2;

FIG. 8 shows a schematic graphic representation to illustrate the temperature dependence of the conductivity;

FIG. 9 shows a schematic graphic representation to illustrate the temperature dependence of the refractive index.

### DETAILED DESCRIPTION OF THE PREFERRED EMBODIMENT

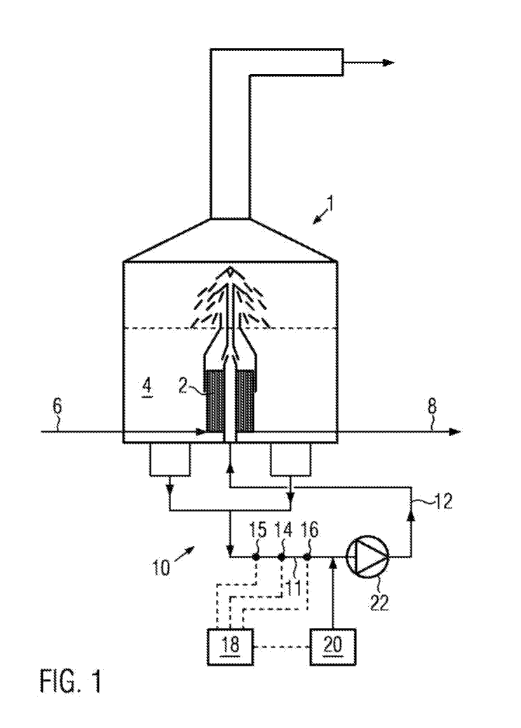

FIG. 1 schematically illustrates an embodiment of the present disclosure. Apparatus 1 is, in this case, a wort boiling device which comprises a process container 4 as well as an inlet and an outlet for the wort (not shown). The wort boiling device comprises a heater 2, in this case in the form of an internal boiler, which operates according to the heat exchanger principle and is heated with a heating medium. The heating medium is, for instance, water vapor, water or thermal oil. The heating medium, in this embodiment water vapor, is supplied to the heater through the supply line 6 and is discharged through the discharge line 8. The apparatus 1 further includes a riser in which the wort that was heated in the heater rises and, subsequently, is distributed in the wort boiling device by a wort guiding screen which is arranged in the upper region. While the wort is heated deposits settle down in the heater 2 in the course of time, as a result of the scorching of organic substances, which deteriorates the heat transfer between the heating medium and the product, so that the heating surfaces of the heater 2 have to be cleaned.

Additionally, a cleaning unit 20 is provided in the apparatus 1, which supplies the cleaning agent, in this case aqueous NaOH solution, during the cleaning process. The apparatus 1 comprises a circulation unit 10 with a circulation pump 22, by means of which the wort is withdrawn during operation from container 4 through the discharge line 11, and is supplied again by means of the circulation pump 22, through supply line 12, to container 4, i.e. in particular to the heater 2. The cleaning agent, which is introduced into the cycle by the cleaning unit 20, circulates in the circulation unit 10 during the cleaning process.

The apparatus 1 further comprises a measuring device 14 for determining the refractive index of the cleaning agent solution, as well as a measuring device 16 for determining the electrical conductivity of the cleaning agent solution. In addition, a measuring device 15 is provided for determining the temperature of the cleaning agent solution, in this case a temperature sensor. These are arranged in the discharge line 11 of the circulation unit 10. The evaluation unit 18 is connected to the measuring devices 14 to 16 as well as to the cleaning device 20 so as to allow an exchange of data. Measuring devices 14 and 16 for determining the refractive index and the electrical conductivity are known in the prior art.

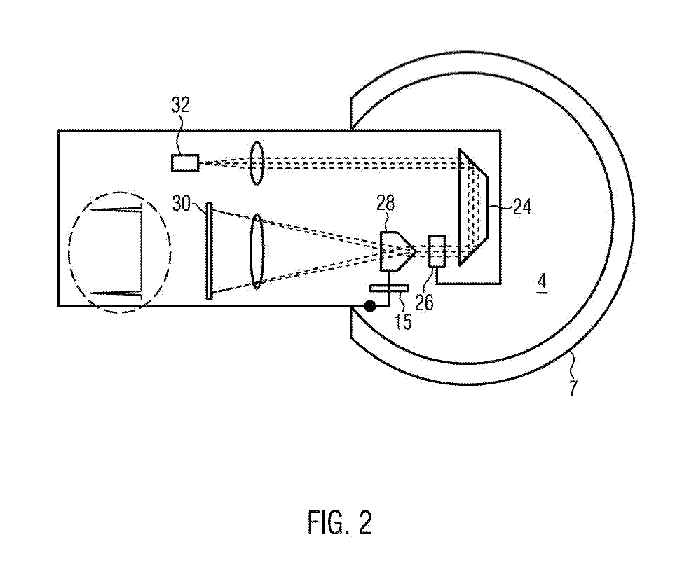

FIG. 2 shows a schematic representation of a refractometer, which serves as measuring device 14 for determining the refractive index of the cleaning agent solution in the apparatus 1. The refractometer comprises a light source 32, a deflection device 24, a measurement window 26. Moreover, a double prism 28 is provided, on which the light beam is refracted and split and directed to a CCD sensor 30. The angle of refraction and, thus, the refractive index can be determined on the basis of the focused slit images. In this preferred embodiment a temperature sensor 15 for measuring the temperature is integrated.

By means of the apparatus according to FIG. 1 the method according to the disclosure can be carried out as follows:

For cleaning the apparatus 1 in a CIP cleaning process aqueous NaOH solution is introduced into the process container 4 by the cleaning device 20 and circulates by means of the circulation unit 10. Separated organic material is successively decomposed in the apparatus 1, in particular in the process container 4, in the process lines of the circulation unit 10 and in the heater 2. During the cleaning process the refractive index, the temperature and the electrical conductivity of the cleaning agent solution are continuously measured in the discharge line 11 of the circulation unit 10 by means of measuring devices 14 to 16. The determined measured data are passed on to the evaluation unit 18, where the NaOH concentration in the cleaning agent solution is continuously determined by means of calibration curves on the basis of the determined measurement data. The so continuously determined NaOH concentration provides information about the change of the NaOH concentration with time during the cleaning process. Subject to this change the evaluation unit 18 controls the cleaning device 20, i.e. gives in particular the instruction to continue with or discontinue the cleaning process, and/or re-concentrate the cleaning agent and/or replace the cleaning agent.

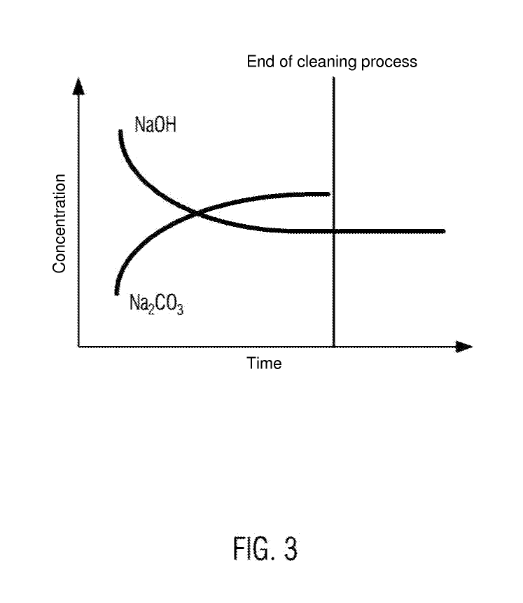

FIG. 3 illustrates the time-dependent course of the NaOH and Na₂CO₃ concentrations in the cleaning agent solution during the cleaning. Initially, the NaOH concentration is reduced during the cleaning process, while the Na₂CO₃ concentration increases. As the cleaning process continues the concentrations of NaOH and Na₂CO₃ in the cleaning agent solution approximate a constant value which defines the end of the cleaning process.

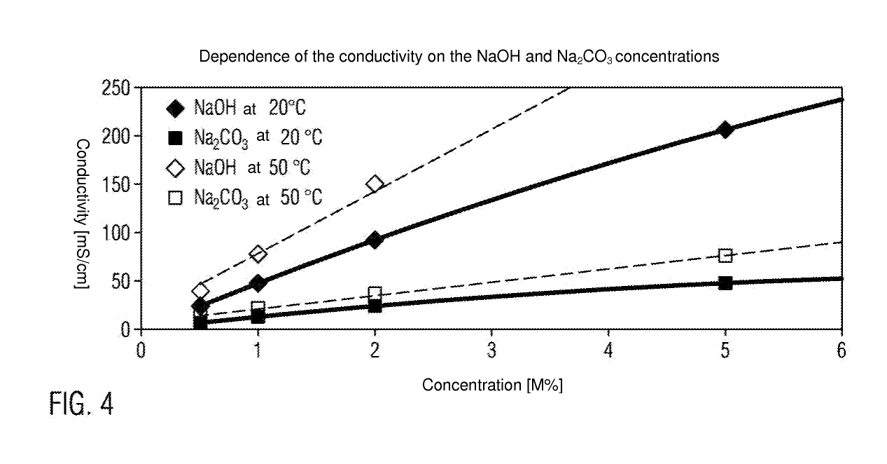

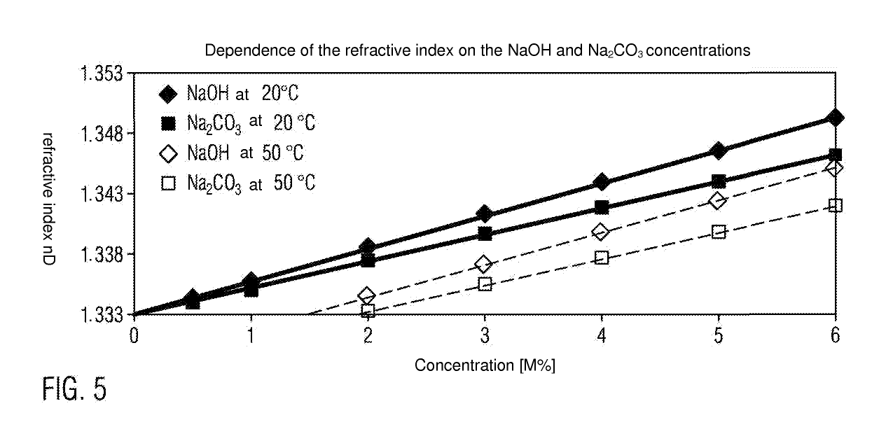

FIG. 4 and FIG. 5 show calibration curves which demonstrate that the concentration of NaOH as well as the concentration of Na₂CO₃ contribute to the measured value of the conductivity and to the refractive index of the cleaning agent solution (in this case at 20° C. and 50° C.). By means of the mathematical equations (i) and (ii) the use of these calibration curves allows the calculation of the respective individual concentration of NaOH and Na₂CO₃ (compensated to 20° C.) in the cleaning agent solution at the time of measurement.

$$\begin{matrix}{Konz}_{NaOH} = \frac{( {nD}_{20} - {F}_{1} ) - ( {LF}_{20} - {F}_{2} ) \cdot {F}_{3}}{{F}_{4}} & ( i ) \\ {Konz}_{{Na}_{2} {CO}_{3}} = \frac{( {LF}_{20} - {F}_{2} ) - ( {nD}_{20} - {F}_{1} ) \cdot {F}_{5}}{{F}_{6}} & ( ii )\end{matrix}$$

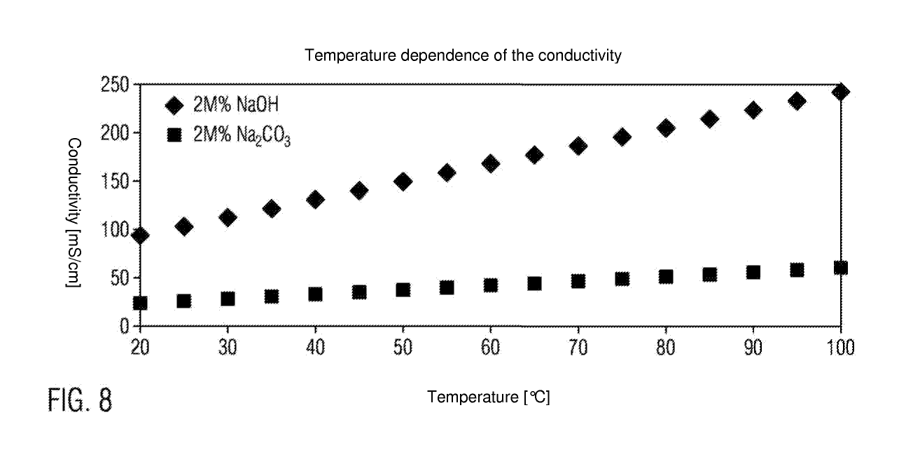

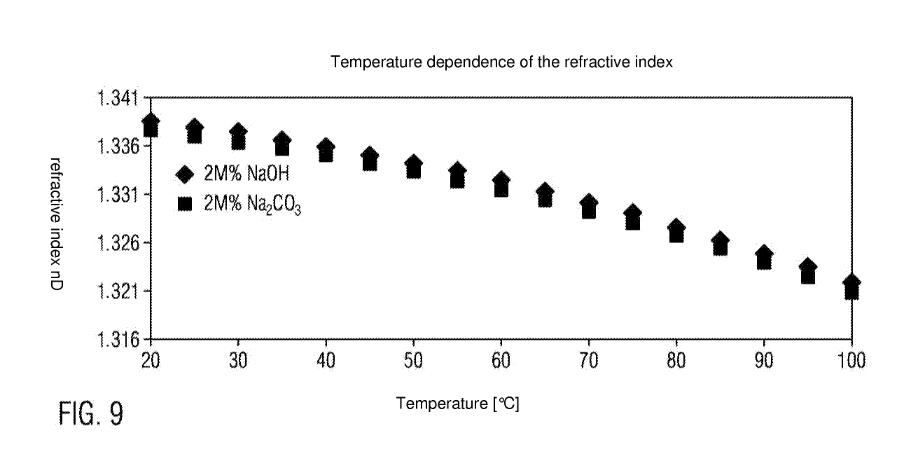

nD₂₀ corresponds to the refractometer value and LF₂₀ to the electrical conductivity, compensated to 20° C. F₁ to F₆ are application-specific coefficients. Using formulae (i) and (ii) shows that the coefficients F₃ to F₆ can be determined solely from the individual dependences of the electrical conductivity and the refractive index at several different temperatures of Na₂CO₃ and NaOH concentrations (see FIG. 4 and FIG. 5). F₁ and F₂ are apparatus-specific constants that are adapted to the process water used. FIG. 8 and FIG. 9 show the temperature dependence of the conductivity and refractive index in 2 mole percentage solutions. Thus, it is possible to determine at a given temperature the respective values of the conductivity and the refractive index, compensated to 20° C.

The present disclosure is further explained by means of Examples 1 and 2. In Examples 1 and 2 a CIP cleaning process was carried out in the apparatus of FIG. 1 as described above, on two different days and according to two different processes. The temperature-compensated refractive index and the temperature-compensated conductivity were determined at different places of the plant, and the NaOH and Na₂CO₃ concentrations were determined. In parallel to this, samples of the cleaning agent were taken at the respective places, and the NaOH and Na₂CO₃ concentrations were determined in a chemical analysis by means of titration.

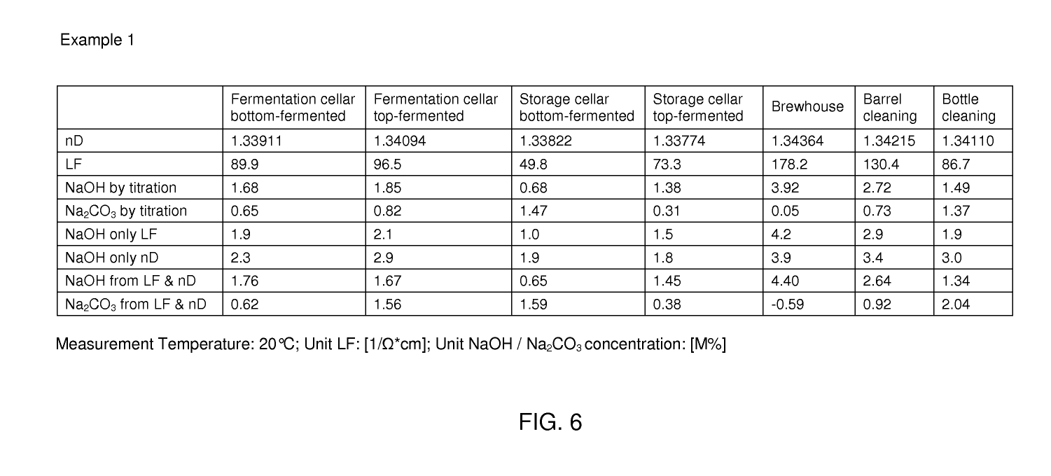

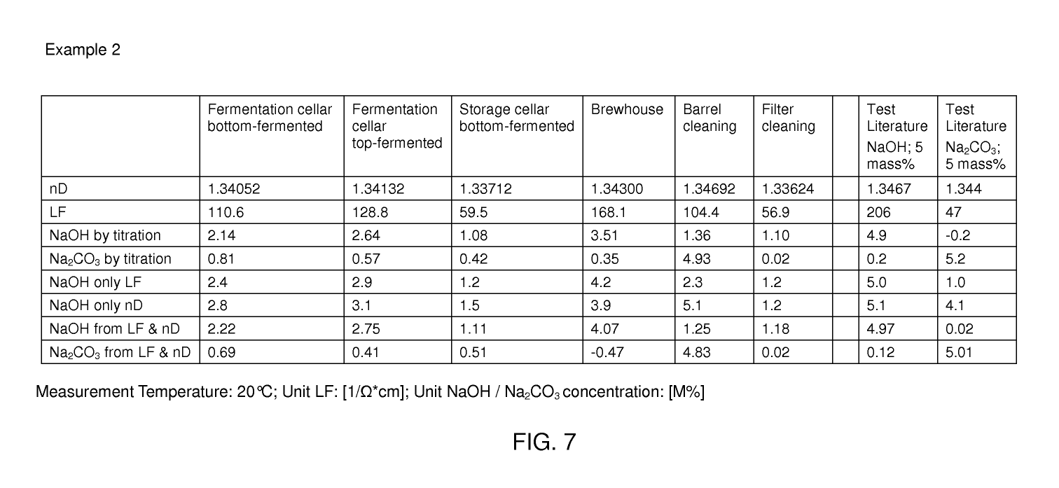

FIGS. 6 and 7 show a summary of the values determined for Examples 1 and 2 in the form of a table. For all places in the unit the determined values show a good correspondence of the results obtained by titration with the determined values obtained by a combination of the conductivity with the refractive index. In particular the NaOH concentration determined by the method according to the disclosure is very exact, that is, the deviations are smaller than those obtained in a pure conductivity measurement.

For Example 2 two tests were performed additionally, in which an NaOH solution of 5% by mass and an Na₂CO₃ solution of 5% by mass were introduced into the already cleaned plant. This case, too, shows a good correspondence of the results obtained by titration with the determined values obtained by a combination of the conductivity with the refractive index. In particular the NaOH content is indicated very exactly, i.e. more exactly as that of a pure conductivity measurement.

1. An apparatus, comprising:
at least one process container and/or at least one process line,
a cleaning device by means of which the process container and/or the process line can be cleaned by introducing a cleaning agent solution,
a first measuring device for determining a first physical substance quantity of the cleaning agent solution,
a second measuring device for determining a second physical substance quantity of the cleaning agent solution, and
a third measuring device for determining the temperature of the cleaning agent solution,
an evaluation unit which determines the cleaning agent concentration in the cleaning agent solution on the basis of the first and second physical substance quantities and on the basis of the temperature of the cleaning agent solution, and determines the continuation or discontinuation of the cleaning, and/or the re-concentration and/or the replacement of the cleaning agent depending on the determined cleaning agent concentration.

2. The apparatus according to claim 1, wherein the refractive index is measured as the first physical substance quantity and the electrical conductivity is measured as the second physical substance quantity.

3. The apparatus according to claim 1, wherein the measuring device is integrated in the first measuring device or in the second measuring device.

4. The apparatus according to claim 1, wherein the apparatus is an apparatus for producing liquid foodstuffs.

5. The apparatus according to claim 1, wherein the cleaning agent solution is an aqueous solution which contains NaOH as cleaning agent, and wherein the cleaning agent solution further contains Na₂CO₃.

6. The apparatus according to claim 1, and further comprising a circulation unit with a circulation pump by means of which the process container and the cleaning device are connected to each other, and wherein the circulation unit comprises a discharge line from the process container to the circulation pump and a supply line from the circulation pump to the process container.

7. The apparatus according to claim 6, wherein one of the first measuring device, the second measuring device, the third measuring device, and a combination thereof are located in the circulation unit.

8. A method for monitoring the cleaning of an apparatus, comprising:
a) cleaning the apparatus with a cleaning agent solution, wherein the cleaning agent is chemically transformed during the cleaning,
b) measuring a first and a second physical substance quantity, and measuring the temperature of the cleaning agent solution,
c) determining the cleaning agent concentration in the cleaning agent solution on the basis of the first and second physical substance quantities and on the basis of the temperature of the cleaning agent solution, and
d) continuing or discontinuing the cleaning, and/or re-concentrating and/or replacing the cleaning agent depending on the determined cleaning agent concentration.

9. The method according to claim 8, wherein the first physical substance quantity is the refractive index and the second physical substance quantity is the electrical conductivity.

10. The method according to claim 8, wherein the apparatus is an apparatus for producing liquid foodstuffs, in particular a brewery plant, and wherein the process container is preferably a mash or wort boiling device/device for keeping hot the wort and/or a fermenting or storage tank and/or a bottle washing machine.

11. The method according to claim 8, wherein the cleaning agent solution is an aqueous solution which contains NaOH as cleaning agent, and wherein the cleaning agent solution in step b) further contains Na₂CO₃.

12. The method according to claim 8, wherein the measurement of the first and second physical substance quantities and of the temperature of the cleaning agent solution in step b) is carried out continuously or at intervals during the cleaning.

13. The method according to claim 8, wherein the determination of the cleaning agent concentration in step c) is carried out by a calibration curve.

14. The method according to claim 8, for cleaning an apparatus having:
at least one process container and/or at least one process line,
a cleaning device by means of which the process container and/or the process line can be cleaned by introducing a cleaning agent solution,
a first measuring device for determining a first physical substance quantity of the cleaning agent solution,
a second measuring device for determining a second physical substance quantity of the cleaning agent solution,
a third measuring device for determining the temperature of the cleaning agent solution, and
an evaluation unit which determines the cleaning agent concentration in the cleaning agent solution on the basis of the first and second physical substance quantities and on the basis of the temperature of the cleaning agent solution, and determines the continuation or discontinuation of the cleaning, and/or the re-concentration and/or the replacement of the cleaning agent depending on the determined cleaning agent concentration.

15. The method according to claim 14, wherein the measurement of the first physical substance quantity and/or of the second physical substance quantity and/or of the temperature in step b) is carried out in the circulation unit.

16. The apparatus according to claim 4, wherein the apparatus is a brewery plant, and wherein the process container is one of a mash or wort boiling device, a device for keeping the wort hot, a fermenting or storage tank, and a bottle washing machine.

17. The apparatus according to claim 7, wherein the one of the first measuring device, the second measuring device, and the third measuring device is located in the circulation unit.

18. The method according to claim 15, wherein the measurement of the first physical substance quality and/or of the second physical substance quality and/or of the temperature in step (b) is carried out in the discharge line.
